(19) United States
(12) Patent Application Publication
(10) Pub. No.: US 2018/0241103 A1
(43) Pub. Date: Aug. 23, 2018

(54) ENERGY STORAGE DEVICE AND MOTOR VEHICLE

(71) Applicant: AUDI AG, Ingolstadt (DE)

(72) Inventor: Markus PFEIFF, Koesching (DE)

(73) Assignee: AUDI AG, Ingolstadt (DE)

(21) Appl. No.: 15/898,302

(22) Filed: Feb. 16, 2018

(30) Foreign Application Priority Data
Feb. 21, 2017 (DE) 102017202768.1

(51) Int. Cl. H01M 10/613; B60K 1/04; F28F 3/12; H01M 10/6554; H01M 10/6556; H01M 10/6568; H01M 10/625

(52) U.S. Cl. CPC H01M 10/613; B60K 1/04; F28F 3/12; H01M 10/6554; B60K 2001/005; H01M 10/6568; H01M 10/625; B60K 2001/0438; H01M 10/6556

(57) ABSTRACT

An energy storage device comprising at least one storage element with an associated cooling plate, with which the storage element is in thermal contact, as well as at least one channel component, which is fastened on the opposite-lying side of the cooling plate for the formation of at least one cooling channel through which a coolant can flow, wherein the cooling channel is at least as wide as and at least as long as the contact surface between the storage element and the cooling plate, wherein the cooling channel lies opposite the contact surface and covers it completely.

### FIELD

The invention relates to an energy storage device comprising at least one storage element with an associated cooling plate, with which the storage element is in thermal contact, as well as at least one channel component, which is fastened to the opposite-lying side of the cooling plate for the formation of at least one cooling channel through which a coolant can flow.

### BACKGROUND

Energy storage devices have come into use, for example, in motor vehicles with electric drive, in which these devices serve for storing the energy required for the electric drive. During operation, such energy storage devices or the individual energy stores and the current-conveying components can heat up intensely, for which reason a cooling of energy storage devices is necessary. Such a cooling can be produced, for example, by connecting the energy storage device thermally to a cooling system.

Thus, the document DE 10 2012 209 306 A1 shows a cooling system for battery cells, in which the battery cells of a battery pack are surrounded by a housing, and this housing is connected to an external cooling system on one side and interacts thermally with the latter. Due to this arrangement, it is achieved that the coolant of the external cooling system also cannot pass into the battery housing in case of a leak.

In the document DE 10 2011 075 989 A1, a device for cooling an energy store of a vehicle is disclosed, wherein the energy store has at least one cooling surface for the exchange of heat energy. A convection tub is associated with this cooling surface, and the tub influences the thermal linking of the energy store to a surface of the convection tub over which air in the surroundings of the vehicle can flow in such a way that the convection tub is filled with a cooling fluid, in order to connect the convection tub in a heat-conducting manner to the energy store.

Document WO 2015/132786 discloses a battery cell arrangement, in which elements that form cooling channels are disposed between individual battery cells. The battery cells can be cooled by a coolant conveyed in the cooling channels.

In the document WO 2013/139908 A1, a cooling device is described for a vehicle battery, in which cooling channels are formed on the outer surface of a cooling plate by a channel plate that is connected to the cooling plate. In this case, heat introduced into the cooling plate can be transported into the cooling channels by circulation of the coolant.

It is a disadvantage in such cooling devices that a good thermal contact between the storage elements and the cooling channels cannot be uniformly provided for all storage elements.

### SUMMARY

Therefore, the invention is based on the object of providing an energy storage device with an improved cooling of a storage element.

In order to achieve this object, it is provided according to the invention that the cooling channel of the energy storage device is at least as wide as and at least as long as the contact surface between the storage element and the cooling plate, wherein the cooling channel lies opposite the contact surface and covers it completely.

The advantage of the solution according to the invention consists in the fact that a large thermal contact surface between the cooling channel and the storage element is achieved by the covering of the cooling channel with the contact surface, whereby the heat that arises in the storage element can be discharged more efficiently through the cooling channel. The channel width and the channel length of the cooling channel in this case are at least dimensioned such that the cooling channel fully includes the contact surface between storage element and cooling plate; in particular, it is also possible that the cooling channel is wider and/or longer than the contact surface between storage element and cooling plate. With circularly formed or otherwise shaped contact surfaces, the channel width or the channel length is selected corresponding to the diameter of the contact surface, so that a complete covering between cooling channel and contact surface is ensured. This means that in the case of a storage element with a rectangular contact surface, for example, an individual battery cell or a battery module, which has, for example, a width of 15 cm and a length of 40 cm, the cooling channel disposed on the opposite-lying side of the cooling plate also has a width of at least 15 cm and a channel length of at least 40 cm, so that the channel completely covers the contact surface. It is also possible that a plurality of storage elements are disposed behind one another or next to one another, whereby in this case, the width or the length of the cooling channel is selected so that the cooling channel completely covers the contact surfaces of all storage elements as well as the intermediate spaces between the storage elements that are present in the device under certain circumstances. Also, the energy storage device may comprise a plurality of cooling channels, and one or more storage elements are assigned to each of these. In order to enable a discharge of heat, a coolant, for example a cooling fluid, flows through the cooling channels. The channel component is fastened to the cooling plate in such a way that the cooling channels are so tight that a coolant conveyed into the cooling channels cannot escape. In this case, the end faces of the cooling channels can be either open or closed, each time depending on the design of the energy storage device.

The cooling channels can be formed in such a way that the channel component with a section bounding the cooling channel has a U-shaped or V-shaped cross section. The side of the cooling channel remaining open in the case of a U-shape or V-shape is closed by the cooling plate in this case, wherein the space now enclosed by cooling plate and the section bounding the cooling channel forms the cooling channel. The channel component may have, in addition to the section bounding the cooling channel, additional sections, in particular applied to the cooling plate, by which the channel component can be fastened to the cooling plate. By arrangement of a plurality of such channel components, a corresponding cooling channel arrangement can be created. For example, the channel components can be designed as folded or stamped sheet metal components and possess protection against corrosion. The cooling plate can also be composed of metal, in particular of a metal with high heat conductivity, and also can have protection against corrosion, in particular at the surface bounding the cooling channel.

For the formation of a plurality of channels, it can be provided that the channel component has a plurality of sections, each bounding a cooling channel. In this way, a channel arrangement of a plurality of cooling channels that are separated from one another can be produced by fastening just one channel component. In this case, the individual cooling channels can each be bounded by a section of the channel component, wherein additional sections can be provided between the sections bounding one cooling channel, and these can be particularly applied to the cooling plate, and the channel component can be fastened to the cooling plate at these sections. The sections bounding a cooling channel can also have here a U-shaped or V-shaped cross section.

Another configuration of the invention provides that a plurality of cooling channels can be produced by providing the channel component with a meandering cross section or in that a channel plate comprises intermediate bridge pieces. In the case of a channel component with meandering cross section, the sections bounding a cooling channel can be alternated with additional sections. The cooling channels are bounded by the cooling plate and by the sections bounding a cooling channel, for example, with U-shaped or V-shaped cross section, wherein an additional section can be found each time between two sections bounding a cooling channel. With these additional sections, in particular, when they are applied flat onto the cooling plate, the channel component can be fastened to the cooling plate. A plurality of cooling channels can also be produced when the channel component comprises a channel plate with intermediate bridge pieces, wherein the intermediate bridge pieces are arranged between the channel plate and the cooling plate. In this case, a cooling channel is bounded by the cooling plate, the channel plate, and at least one intermediate bridge piece. Individual cooling channels are separated in this case by the intermediate bridge pieces. A channel plate with intermediate bridge pieces and a channel component with meandering cross section can be designed, for example, as a correspondingly shaped sheet metal part and have protection against corrosion.

According to the invention, the energy storage device can be designed in such a way that it comprises a plurality of cooling channels, wherein the cooling channels are open at the end faces thereof, or wherein the cooling channels are joined together at their end faces for the formation of a meandering section, or wherein each cooling channel is closed at its end faces, but has at least two connections arranged at a side surface of the cooling channel. In the case of cooling channels with open end faces, it can be provided that the cooling channels run parallel to one another and a supplying or a discharging of the coolant is produced via the respective end faces. It is also possible that the cooling channels are joined at their sides in order to form a meandering section by way of connection channels, wherein an end face of a cooling channel at the beginning of the meandering section and an end face at the end of the meandering section remain open, and these can be used for supplying or discharging the coolant. As an alternative to this, it is also possible that each cooling channel is closed at its end faces and has at least two connections, by way of which the coolant can be supplied or discharged. These connections can be arranged, for example, at a side surface of the cooling channel. It is also possible that in the case of cooling channels joined into a meandering section, the end faces at the beginning and end of the meandering section are closed, and that the supplying or discharging of the coolant is also produced here by way of correspondingly arranged connections.

According to the invention, it may be provided that the channel component is fastened to the cooling plate by common connection techniques, such as adhesive bonding, screws, or welding. The adhesive bonding or welding of the channel component in this case can be produced at the additional sections of the channel component. The connection site is to be designed in a media-tight manner, e.g., by use of a sealant, if the connection technique itself has not already produced a tight connection. In this case, the adhesive bonding or welding achieves a tight sealing of the cooling channel or of the cooling channels, so that during operation, coolant cannot leak at these sites.

Another configuration of the invention provides that additional components of the energy storage device, in particular, high-voltage lines, are arranged on the cooling plate, wherein the additional components are connected to the cooling plate in a thermally conductive manner, wherein the contact surfaces are comprised by the cooling channel between component and cooling plate. The cooling channel in this case is wide enough and long enough, so that the surfaces on which additional components, such as, for example, high-voltage lines, are also arranged, are covered by the cooling channel on the opposite-lying side of the cooling plate. In this way a discharge of heat produced in the components is additionally made possible for cooling the storage elements.

For a motor vehicle according to the invention, it is provided that it has an energy storage device according to the invention. The motor vehicle may involve, for example, a motor vehicle with electric drive, in which the energy storage device serves for storing the energy required for the drive.

A motor vehicle, which, in addition to an energy storage device according to the invention, also comprises a vehicle body and a coolant circuit, can be designed according to the invention so that the cooling channel or the cooling channels of the energy storage device is or are connected to the coolant circuit by way of at least one component of the vehicle body, which has a cooling channel and is integrated into the coolant circuit. The coolant circuit of the motor vehicle in this case can comprise, for example, a pump, a heat exchanger, and corresponding lines for the formation of a coolant circuit. In this case, a component of the vehicle body can be integrated into the coolant circuit, and in its turn, the component has a cooling channel through which the coolant can be supplied to the cooling channel or the cooling channels of the energy storage device or can be discharged from the latter. It is also possible that the motor vehicle has two components of the vehicle body, each of which has a cooling channel, wherein the coolant flows through one of the components of the vehicle body as an inlet channel to the cooling channels of the energy storage device, after which it is discharged through the cooling channel of the second component. Each time depending on the design of the cooling channels of the energy storage device, each of the cooling channels can be connected by way of its end face to one of the vehicle body components, or in the case of cooling channels connected in a meandering manner, the beginning and the end of the meandering section are joined to the components of the vehicle body, or the cooling channels of the components of the vehicle body are joined, for example, to connections arranged at side surfaces of the channels.

One component of the vehicle body can be a component, in particular a side skirt, arranged laterally in the motor vehicle. In this case, the component of the vehicle body can be arranged, for example, so that the coolant is supplied to the cooling channels of the energy storage device through the cooling channel of the vehicle body component. Thus, it is possible, for example, that in the case of cooling channels with open end faces, these faces are joined to the cooling channel of the vehicle body component.

In addition, it may be provided that the motor vehicle has two side skirts, each having a cooling channel, wherein one cooling channel is an inlet channel and the other cooling channel is an outlet channel, wherein the inlet channel and the outlet channel are joined to the one or more cooling channels of the energy storage device. Such an arrangement makes possible a symmetric weight distribution of the energy storage device as well as the components of the vehicle body in the motor vehicle that are integrated into the cooling circuit.

In order to make possible a linking of the components of the vehicle body to the cooling channels of the energy storage device, it can be provided that the cooling plate has at least one opening, through which the one or more cooling channels of the energy storage device are connected to the cooling channel of the component of the vehicle body. It is also possible that the cooling plate has a plurality of openings, by which several cooling channels of the energy storage device are connected on the side of the inlet channel and the side of the outlet channel to the cooling channels of the components of the vehicle body, which are designed, for example, as side skirts.

### BRIEF DESCRIPTION OF THE DRAWINGS

Additional advantages and details of the invention result from the examples of embodiment described in the following, as well as based on the drawings. Here:

FIG. 1 shows a lateral view of a motor vehicle according to the invention;

FIG. 2 shows a perspective view of an example of embodiment of an energy storage device according to the invention;

FIG. 3 shows a lateral view of an embodiment of an energy storage device according to the invention;

FIG. 4 shows a lateral view of an embodiment of an energy storage device according to the invention;

FIG. 5 shows a lateral view of an embodiment of an energy storage device according to the invention;

FIG. 6 shows a top view of an embodiment of an energy storage device according to the invention;

FIG. 7 shows a top view of an embodiment of an energy storage device according to the invention;

FIG. 8 shows a top view of an embodiment of an energy storage device according to the invention;

FIG. 9 shows a cutaway view of a detail of a motor vehicle according to the invention; and

FIG. 10 shows a cutaway top view onto a detail of a motor vehicle according to the invention.

### DETAILED DESCRIPTION OF THE DRAWINGS

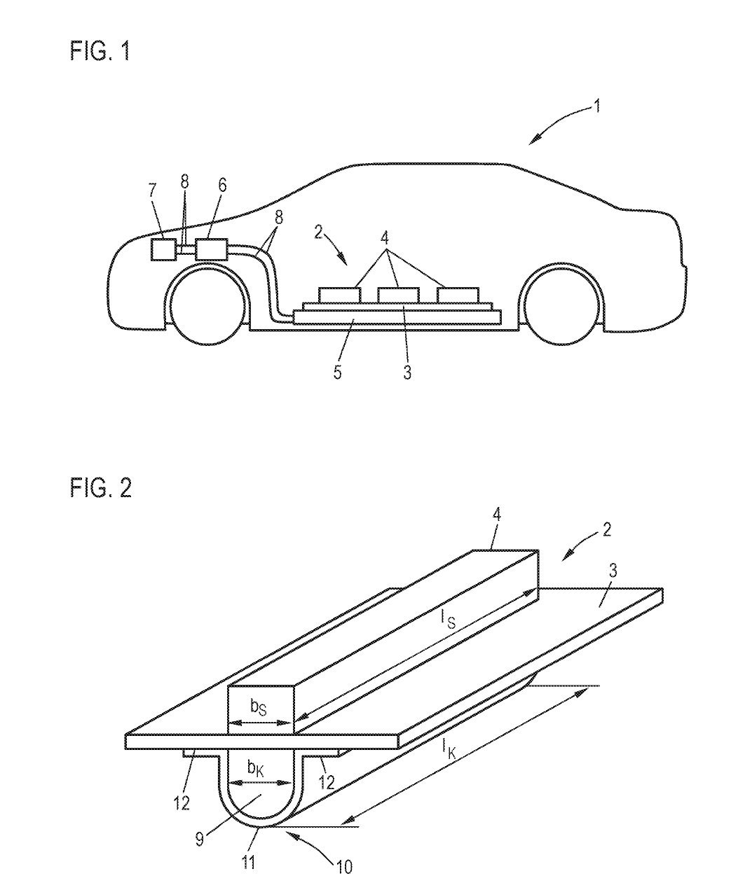

The motor vehicle 1 shown in FIG. 1 has an energy storage device 2, which comprises a plurality of storage elements 4 arranged on a cooling plate 3. The energy storage device 2 is connected by way of a component 5 of the vehicle body to a cooling circuit of the motor vehicle 1, wherein the cooling circuit comprises a pump 6, a heat exchanger 7, and coolant lines 8. The circulating coolant is moved by means of the pump 6, so that the waste heat produced by the energy storage device 2 can be delivered to the surroundings of the motor vehicle by way of the heat exchanger, which leads to a cooling of the energy storage device 2.

FIG. 2 shows a perspective view of an energy storage device 2 according to the invention, in which a storage element 4 is arranged on one side of the cooling plate 3, wherein a cooling channel 9 is formed by a channel component 10 fastened to the cooling plate 3 on the side of the cooling plate 3 lying opposite to the storage element 4. In this case, the channel has a channel width bₖ and a channel length lₖ. The storage element 4 arranged on the opposite-lying side of the cooling plate 3 has a width bₛ and a length lₛ, and thus has a rectangular contact surface relative to the cooling plate 3, with the edge lengths bₛ and lₛ in this example. In order to obtain an optimal discharge of heat from the storage element 4, it is provided, for the channel, that the channel width bₖ is at least as wide as the width of the storage element bₛ and the channel length lₖ is at least as long as the length of the storage element lₛ. In this case, due to the opposite-lying arrangement of the cooling channel 9 to the storage element 4, the cooling channel 9 covers by its channel width bₖ and its channel length lₖ at least the contact surface between storage element 4 and the cooling plate 3. The cooling channel 9 is formed by the section 11 of the channel component 10 bounding a cooling channel, wherein the upper end of the cooling channel is closed by the cooling plate 3. The channel component 10 has additional sections 12, with which the channel component can be fastened to the cooling plate 3. Such a fastening can be produced, for example, in the case of a channel component 10 executed from sheet metal and in the case of a cooling plate 3 composed of a heat-conducting metal, by a tight adhesive bonding or welding to the contact surfaces between the sections 12 and the cooling plate 3. In addition, the components may have a protection against corrosion in order to prevent damage due to the coolant. This applies also to the other exemplary embodiments shown in the following.

Based on the covering of the cooling channel with the contact surface between storage element 4 and the cooling plate 3, a transfer of heat produced in the storage element 4 to the coolant circulating in the cooling channel 9 is produced over the complete contact surface, whereby the storage element 4 is cooled. It is possible that a plurality of storage elements 4 are arranged next to one another or behind one another, wherein, in this case, the channel width bₖ and/or the channel length lₖ is/are selected so that the cooling channel 9 comprises all of the contact surfaces of the arrangement of storage elements 4. For an arrangement of storage elements 4, where distances between the individual storage elements 4 are involved, the channel width bₖ widens or the channel length lₖ lengthens at least by the amount of the distances between the storage elements 4.

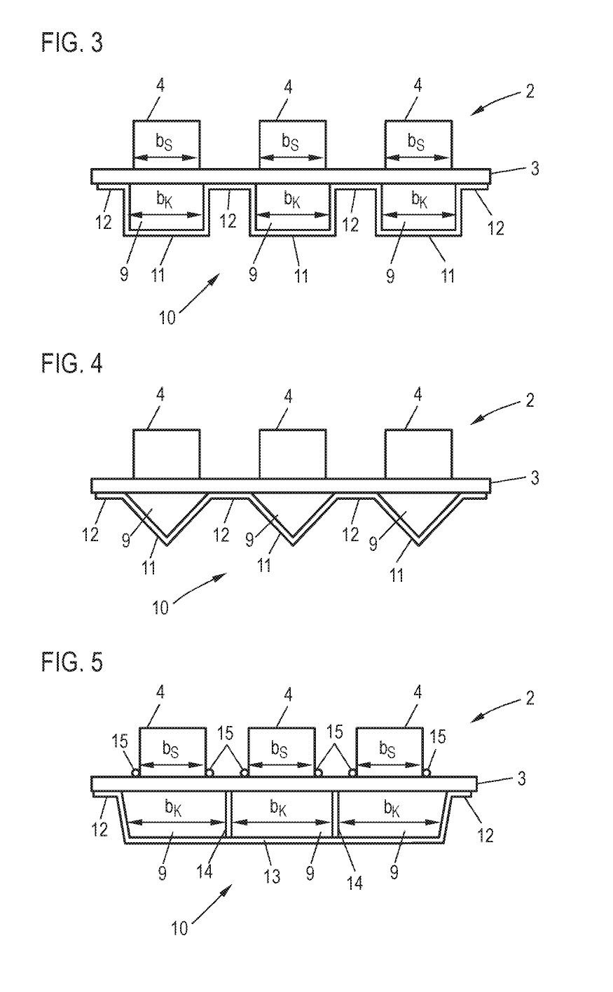

FIG. 3 shows an exemplary embodiment of a storage device 2 according to the invention, in which a plurality of cooling channels 9 are formed by a channel component 10. The channel component 10 in this case has a meandering structure, wherein sections 12 that are applied to the cooling plate 3 are provided in each case at the ends of the structure and between the sections 11 that form a cooling channel. The channel component 10 can be connected to the cooling plate 3 via the sections 12. In this exemplary embodiment, the channel width bₖ is wider than the width bₛ of the storage elements 4. The channel length lₖ running orthogonal to the plane of the drawing in this case amounts to at least the length lₛ of the storage elements 4, this length also running orthogonal to the plane of the drawing, or in the case of a plurality of storage elements 4, which are arranged behind one another, at least the sum total of the lengths lₛ plus the optionally present distances between the storage elements 4. In this example of embodiment, as in all other embodiment examples, it is possible to set up any number of cooling channels 9 by a corresponding configuration of the channel component 10; storage devices 2 with any number of cooling channels 9 can thus be realized correspondingly.

FIG. 4 shows an alternative example of embodiment of an energy storage device 2, which comprises a plurality of cooling channels 9. The cooling channels 9 in this example are formed of V-shaped sections 11 of the channel component 10, sections that bound a cooling channel. Additional sections 12, to which the channel component 10 is fastened to the cooling plate 3, are found between the V-shaped sections 11 bounding a cooling channel.

Another exemplary embodiment is shown in FIG. 5, wherein the cooling channels 9 are formed there by a channel component 10, which comprises a channel plate 13 and intermediate bridge pieces 14. In this case, a cooling channel 9 is bounded by the cooling plate 3, the channel plate 13, and at least one intermediate bridge piece 14. The channel plate 13 in this case is connected to the cooling plate 3 at its edges; the intermediate bridge pieces 14 are connected, sealed against coolant, to both the cooling plate 3 and the channel plate 13. Like the channel plate 13, the intermediate bridge pieces 14 can also be fabricated of sheet metal and have protection against corrosion. As an alternative to this, it is possible that both the channel plate 13 and the intermediate bridge pieces 14 are produced in one piece from a folded or stamped sheet metal. The channel width bₖ of the channels 9 in this example is so wide that, in addition to the width of the storage elements bₛ, it also completely covers the contact surfaces of high-voltage lines 15 arranged next to the storage elements 4. In this way, a heat discharge is also made possible for heat produced by the high-voltage lines 15. In addition to the high-voltage lines 15, other components, such as control devices or switching elements, can also be arranged opposite to the surface comprising the cooling channel, in order to also cool these components.

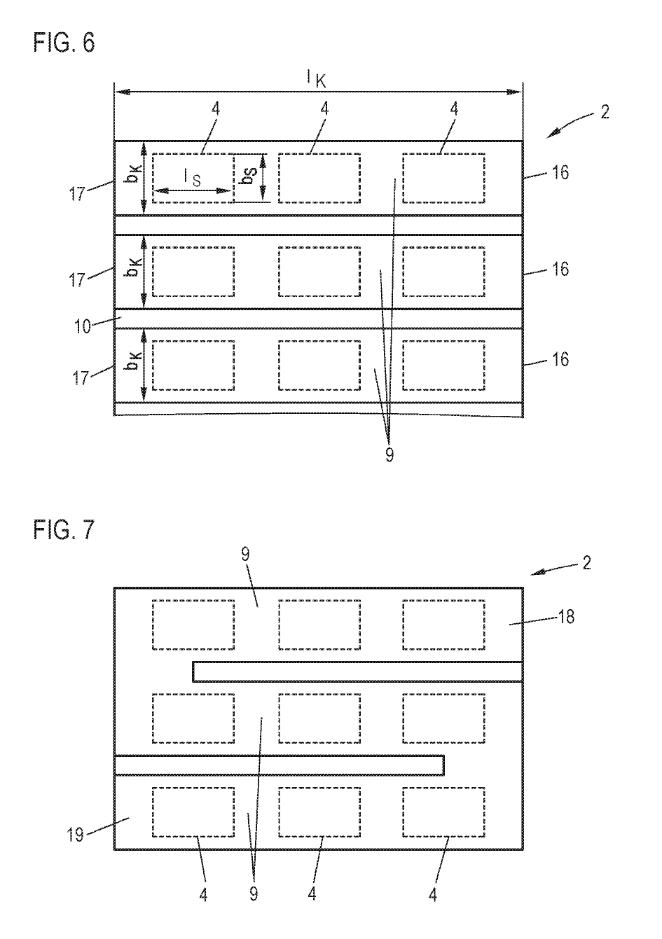

FIG. 6 shows a top view onto a channel component 10 forming a plurality of cooling channels 9 of an energy storage device 2. The storage elements 4 arranged on the opposite-lying side of the cooling plate 3 are shown here by the dashed lines. The channel length lₖ is selected here so that it also comprises the distances between the storage elements 4 in addition to the lengths lₛ of the storage elements 4 arranged in a row. Each of the cooling channels 9 has two open end faces 16, 17 in this example, wherein, for example, in each case, a coolant inlet channel can be produced by the end faces 16, and a corresponding coolant outlet channel can be produced by way of the end faces 17. Due to the coolant circulating in this way through the cooling channels 9, the storage elements 4 arranged on the other side of the cooling plate 3 are cooled.

FIG. 7 shows an alternative configuration of the invention, in which the cooling channels are joined to form a meandering section. The meandering section in this case runs in such a way that the contact surfaces of the storage elements 4 arranged on the other side of the cooling plate and shown here by the dashed lines are completely covered. In addition, the meandering section has two ends 18, 19, which can be either designed as open, so that, e.g., a coolant inflow can be produced through the end 18 and a corresponding coolant outflow can be produced by way of the end 19, or the ends 18, 19, can be designed as closed, wherein a coolant inflow can be produced by way of additional connections arranged at the cooling channels and not shown here.

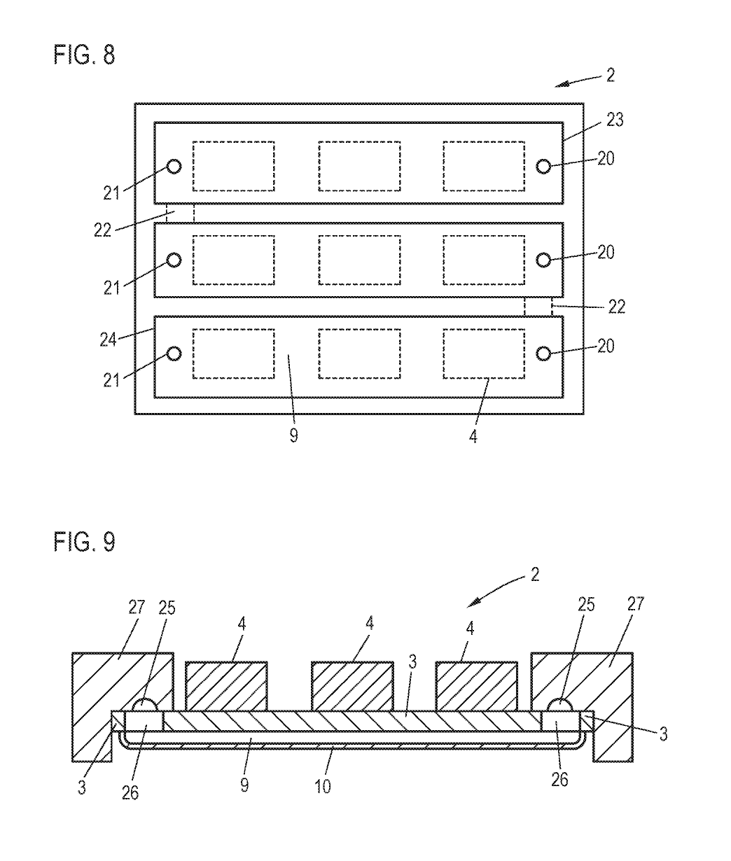

An alternative example of embodiment of an energy storage device 2 according to the invention is shown in FIG. 8. The cooling channels 9 formed by the channel component 10 in this case are closed at their end faces. A coolant inflow is produced by way of the connections 20 provided therefor; a corresponding coolant outflow is produced by way of the connections 21. As an alternative to this, it is possible that the cooling channels 9 are connected into a meandering structure by connection channels 22 shown here by the dashed lines, wherein, for example, a coolant inflow is produced via the connection 20, which is arranged at a first end 23 of the meandering section, and, after passing through the meandering section formed by the cooling channels 9, the coolant flows out at the second end 24 of the meandering section via the connection 21 arranged therein. Due to the flow of coolant through the cooling channels 9, the storage elements 4 arranged on the other side of the cooling plate 3 are cooled.

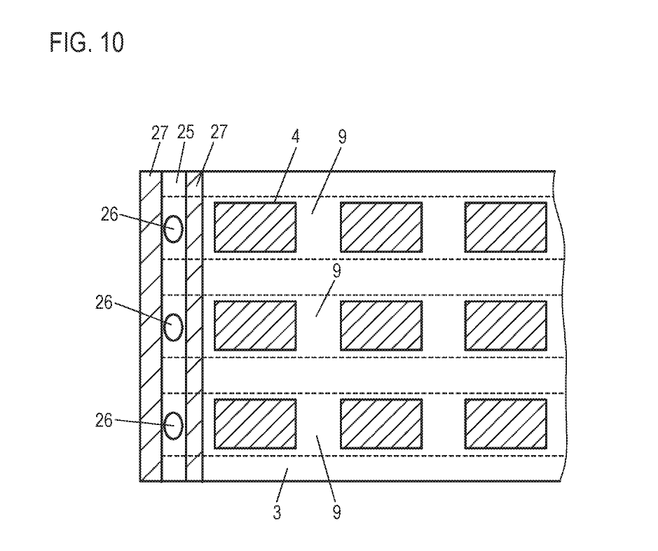

FIG. 9 shows a cutaway view of a detail of a motor vehicle 1 according to the invention, in which an energy storage device 2 is provided, this device having a cooling plate 3, a plurality of storage elements 4, and a cooling channel 9 formed by a channel component 10, wherein the cooling channel 9 is connected to the coolant circuit of the motor vehicle by way of two components 5 of the vehicle body. The components 5 of the vehicle body in this case are designed as side skirts 27 and each of these has a cooling channel 25. A connection between the cooling channels 25 of the side skirts 27 to the cooling channel 9 of the energy storage device 2 is produced by way of openings 26 of the cooling plate 3 provided therefor. With such an arrangement, the coolant can be supplied, for example, via one side, whereupon an outflow of the coolant is produced by way of the side skirt 27 on the other side of the motor vehicle. A corresponding motor vehicle in this case can comprise an energy storage device 2, which has a plurality of cooling channels 9 that run, in particular, parallel to one another. A partially cutaway top view onto a corresponding arrangement is shown in FIG. 10. Each cooling channel 9 is connected by way of an opening 26 to the cooling channel 25 of the side skirt 27, this channel running in the lengthwise direction of the vehicle in this example. In the case of an energy storage device 2 with cooling channels 9 connected into meandering sections, the cooling plate 3 can be configured so that it has only one opening 26 per side, so that a coolant inflow can be produced by way of one side at the beginning of the meandering section and a coolant outflow can be produced from the end of the meandering section on the other side of the motor vehicle.

1. An energy storage device comprising:
at least one storage element with an associated cooling plate, with which the storage element is in thermal contact, and at least one channel component, which is fastened on the opposite-lying side of the cooling plate for the formation of at least one cooling channel through which a coolant can flow, wherein the cooling channel is at least as wide as and at least as long as the contact surface between the storage element and the cooling plate, wherein the cooling channel lies opposite the contact surface and covers it completely.

2. The energy storage device according to claim 1, wherein the channel component with a section bounding the cooling channel has a U-shaped or V-shaped cross section.

3. The energy storage device according to claim 1, wherein the channel component has a plurality of sections, each bounding a cooling channel.

4. The energy storage device according to claim 3, wherein the channel component has a meandering cross section or in that it comprises a channel plate with intermediate bridge pieces.

5. The energy storage device according to claim 1, wherein the energy storage device comprises a plurality of cooling channels, wherein the cooling channels are open at the end faces, or wherein the cooling channels are joined together at their end faces for the formation of a meandering section, or wherein each cooling channel is closed at its end faces and has at least two connections arranged at a side surface of the cooling channel.

6. The energy storage device according to claim 1, wherein the channel component is fastened by adhesive bonding, screws, or welding to the cooling plate.

7. The energy storage device according to claim 1, wherein additional components of the energy storage device, in particular, high-voltage lines, are arranged on the cooling plate, wherein the additional components are connected to the cooling plate in a thermally conductive manner, wherein the contact surfaces between components and cooling plate are included by the cooling channel.

8. A motor vehicle, comprising:
an energy storage device according to claim 1.

9. The motor vehicle according to claim 8, wherein the motor vehicle comprises a vehicle body and a coolant circuit, wherein the cooling channel or the cooling channels of the energy storage device is or are connected to the coolant circuit by way of at least one component of the vehicle body, which has a cooling channel and is integrated into the coolant circuit.

10. The motor vehicle according to claim 9, wherein the component of the vehicle body is a component arranged laterally on the motor vehicle, in particular a side skirt.

11. The motor vehicle according to claim 10, wherein the motor vehicle has two side skirts, each having a cooling channel, wherein one cooling channel is an inlet channel and the other cooling channel is an outlet channel, wherein the inlet channel and the outlet channel are joined to the one or more cooling channels of the energy storage device.

12. The motor vehicle according to claim 9, wherein the cooling plate has at least one opening, by which the cooling channel of the energy storage device is connected to the cooling channel of the component of the vehicle body.
